(19) United States
(12) Patent Application Publication
(10) Pub. No.: US 2002/0069214 A1
(43) Pub. Date: Jun. 6, 2002

(54) Document services architecture

(76) Inventors: John M. Smith, Pittsford, NY (US); Ernest L. Legg, Fairport, NY (US); Shelley A. Hayes, Rochester, NY (US)

Correspondence Address: Patent Documentation Center, Xerox Corporation, Xerox Sq. 20th Floor, 100 Clinton Avenue, Rochester, NY, 14644, US

(21) Appl. No.: 09/728,367

(22) Filed: Dec. 4, 2000

Related U.S. Application Data
(60) Provisional application No. 60/168,587, filed on Dec. 2, 1999.

(51) Int. Cl. G06F 15/00

(52) U.S. Cl. 707/500

(57) ABSTRACT

A document architecture system for managing documents having business critical data and generating new documents for a user, wherein each of the documents having business critical data are derived across a plurality of heterogeneous program applications and environments, the system including a DocuBroker for mediating between the plurality of heterogeneous program applications and the documents having business critical data; a message broker, coacting with said DocuBroker, for retrieving and transferring business critical data from one of said plurality of heterogeneous program applications and environments to be used by another of said plurality of heterogeneous program applications and environments; a DocuBrowser for selecting selective portions of said business critical data; and a DocuManager for generating new business documents based on predefine business parameters, in response to said DocuBrowser, said DocuManager include means for analyzing selective portions of said business critical data; means for storing said new business documents, means for distributing said new documents across said plurality of heterogeneous program applications and environments.

### DOCUMENT SERVICES ARCHITECTURE

This application is based on Provisional Application No. 60/168,587 filed Dec. 2, 1999.

### FIELD OF THE INVENTION

The invention relates generally to a system architecture for an enterprise document solution that addresses the entire scope of the business process and document processing requirements.

### BACKGROUND OF THE INVENTION

In today's document handling and services arena, customers want a family of products that support standard communications and data stream formats, provide a consistent and broad selection of services, and print/display in a consistent and predictable manner. For the future, customer's needs for document services including document scanning, management, and printing must be meet with a broad range of consistent, cost-effective products. Such products must be compatible with multiple standard printing environments, print languages, and printer resources such as forms and fonts. They must also seamlessly integrate into the customer's existing network and/or communications facilities. For many customers, this will require support for several different connectivity architectures on a single machine, emulation of other printing environments, and the ability to access services resident on other networked machines, file servers, data bases, internet and standard customer computing services.

In the prior art, there are numerous patents on the subject of systems. For example, U.S. Pat. No. 4,918,588 to Barrett et al discloses an office automation system with scanner, camera, optical character recognition means, printer, disk storage, computer, image traffic controllers and telecommunication lines for integrated image management. And, U.S. Pat. No. 4,190,350 to Donohue et al, discloses a distributed system for a copier/duplicator with master controller and plural area controllers, one or more of which is smart. Further, there are prior art disclosures to various terminal configurations such as U.S. Pat. No. 4,587,633 to Wang et al which discloses a management communication terminal system with scanning camera, personal computer, telecommunication controller, CRT monitor, and raster printer for use in an office information system. Also, U.S. Pat. No. 4,348,739 to Deaver et al, which discloses a terminal for connection to a data communication system for supplying data to an output printer or display. And, there are disclosures in the prior art to controllers for image processors such as U.S. Pat. No. 4,811,052 to Yamakawa et al which discloses a control device for an imaging processing apparatus using a plurality of operation control units coupled to a central processing unit.

U.S. Pat. No. 5,243,518 discloses a layered document services architecture facilitating operation and interconnection of electronic printing systems with both resident and non-resident work inputs, comprising: a resource layer providing a series of discrete modules and facilities for processing work; an application layer for enabling input of work from both resident and non-resident sources including a document services section and a service manager for coordinating and controlling access to the modules and facilities of the resource layer; and a control layer providing an operating system for coupling the service manager and facilities together in an operating environment, the control layer including a resource controller for prioritizing and distributing system resources to facilities in accordance with program inputs and system operating conditions.

However, there is an increasing need for managing portions of data contained in documents, i.e. business critical data, and the creation and use of this information across heterogeneous applications and environments. For example, the reengineering of business processes is a constant state occurring at ever shortening intervals. As enterprises virtually organize, as new Internet influenced extended enterprise models emerge, and market windows shorten, the ability to quickly reengineering the macro and micro business processes becomes critical. Mission-critical documents (e.g. proposals, contracts, orders, invoices, remittances, and status handshakes) are the vehicle for executing the business processes. These documents are dynamically constructed, exchanged and analyzed at business partner, customer, and supplier interface points according to business process rules, and in essence, are the embodiment of the business.

However, (as shown in FIG. 1) past and existing solutions only address portions of these requirements and therefore provide a fragmented solution. There is not available a holistic solution with a theme based on the document concept. The previous solutions have the following deficiencies: They burden the human 1 with locating information across a variety of applications 2 and 3. The human 1 provides the integration rules of combining semantically different data (such as data from application 2 and 3) and information (e.g. documentsw4, phone calls 5, mail 6 and electronic documents 7) into knowledge. They do not provide an embedded, automated change management process to maintain document content versions and updates as content is updated. The document creation processes are not quick, easily repeatable, reliable, transferable or scalable. The content of the document becomes disconnected and untraceable to the content of the systems. This causes cycle time delays and quality degradation when business process transactions, steps are a combination of system application transactions and document transactions. Ultimately, it results in a loss of enterprise state in severe cases. The content of the systems becomes increasingly disconnected at the data, information, and knowledge levels. As new systems are added to the landscape, interface complexity increases and binds the enterprise business processes.

There is a need that Mission-critical document systems must address the requirements of today's business processes: facilitate use of old business programs and system to new programs and systems migration, enable continuous process evolution, provide real-time process execution, enable electronic business to business transactions, produce optimized documents for individual customers including consolidated customer documents and multiple media for document distribution on demand (Web protocols, EDI, remote print).

### SUMMARY OF THE INVENTION

The present invention obviates the problems noted above by utilizing a document architecture system for managing documents having business critical data and generating new documents for a user, wherein each of the documents having business critical data are derived across a plurality of heterogeneous program applications and environments, the system including a DocuBroker for mediating between the plurality of heterogeneous program applications and the documents having business critical data; a message broker, coacting with said DocuBroker, for retrieving and transferring business critical data from one of said plurality of heterogeneous program applications and environments to be used by another of said plurality of heterogeneous program applications and environments; a DocuBrowser for selecting selective portions of said business critical data; and a DocuManager for generating new business documents based on predefine business parameters, in response to said DocuBrowser, said DocuManager include means for analyzing selective portions of said business critical data; means for storing said new business documents, means for distributing said new documents across said plurality of heterogeneous program applications and environments.

An object of the present invention is to provide a software system architecture for managing mission-critical documents through their lifecycle in enterprises that promotes reengineering of business processes.

### BRIEF DESCRIPTION OF THE DRAWINGS

FIG. 1 is a process flow chart of prior art in applications and document processing.

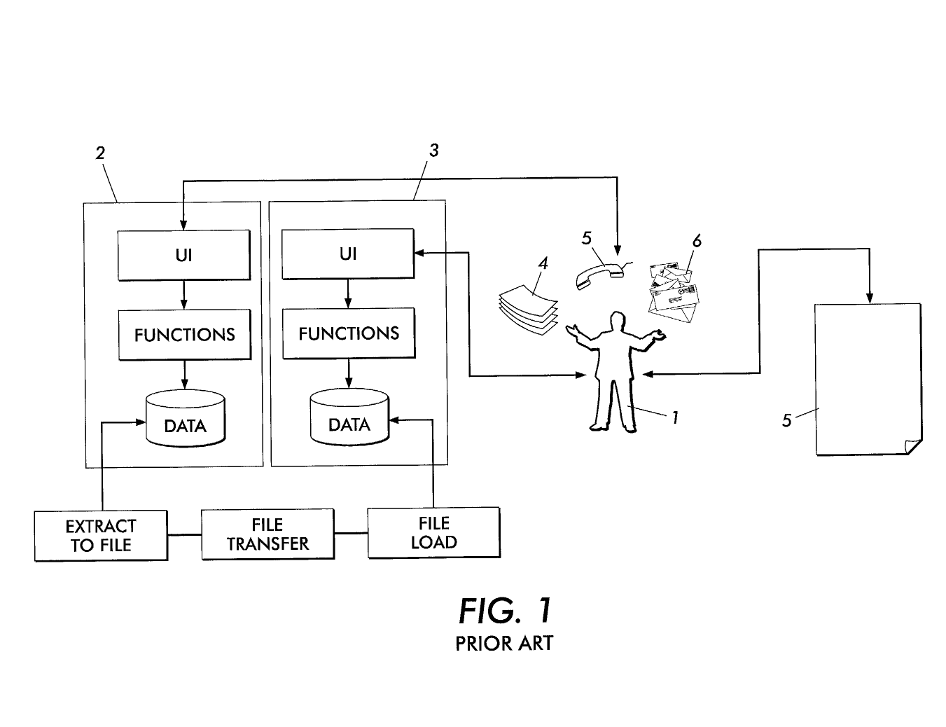

FIG. 2 is a process flow chart of DocuBroker of the present invention

FIG. 3 is a process flow chart of DocuBroker Structure-Level

FIG. 4 is a process flow chart of DocuBrowser high-level functions and structure

FIG. 5 is a process flow chart of Message Broker functional and structure decomposition

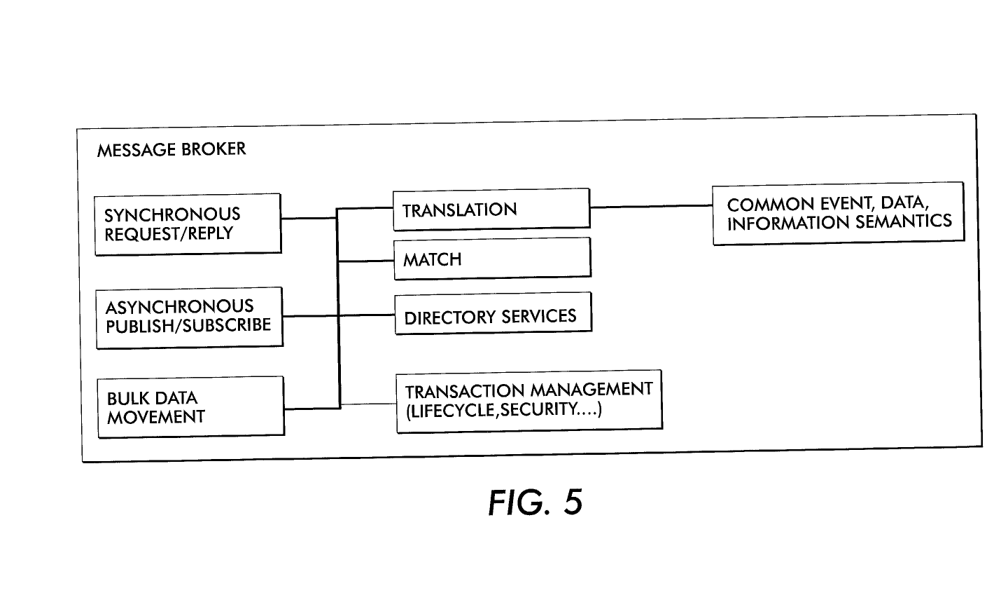

FIG. 6 is a process flow chart of Document Management decomposition and structure

### DETAILED DESCRIPTION OF THE INVENTION

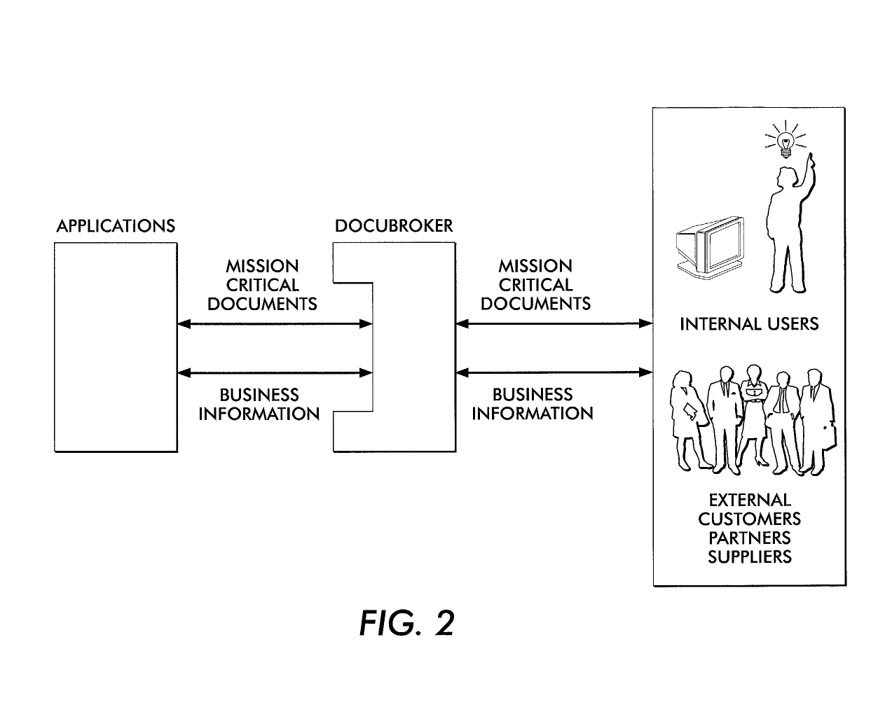

The DocuBroker is a system that mediates between enterprise business applications and mission-critical documents used by internal and external business applications or humans. The DocuBroker is a true broker of knowledge. Based on built-in rules, the DocuBroker will convert data from business applications into the customized knowledge documents required by users or other business applications, and will also analyze documents provided by users or other business applications to extract the data, information, and knowledge required by business applications. FIG. 2 illustrates this fundamental concept of brokerage. The added value of the DocuBroker is that it can execute the business rules for constructing documents, analyzing documents, distributing documents and storing the documents through their lifecycle. While the DocuBroker maintains the ability to systematically maintain the state of application information and documents, it decouples document management from business applications. This allows these applications to be upgraded and migrated over time without impacting documents and business processes.

Mission-Critical Documents: Mission-critical documents are the knowledge documents that an enterprise uses to drive its business. While these documents vary to some degree from business to business, they include such documents as product catalogs, proposals, contracts, orders, invoices and remittances. These documents are all dynamically constructed from business knowledge components consisting of format templates or protocol and knowledge content. For example, proposals are constructed from boilerplate format, preexisting static content components such as Company branding and some new dynamic content components such as current price, and formatted as an integrated document. Orders are constructed from customer data, product data, pricing data and installation data, together with legal terms and conditions. Invoices are constructed from customer data, product and service data, and pricing data.

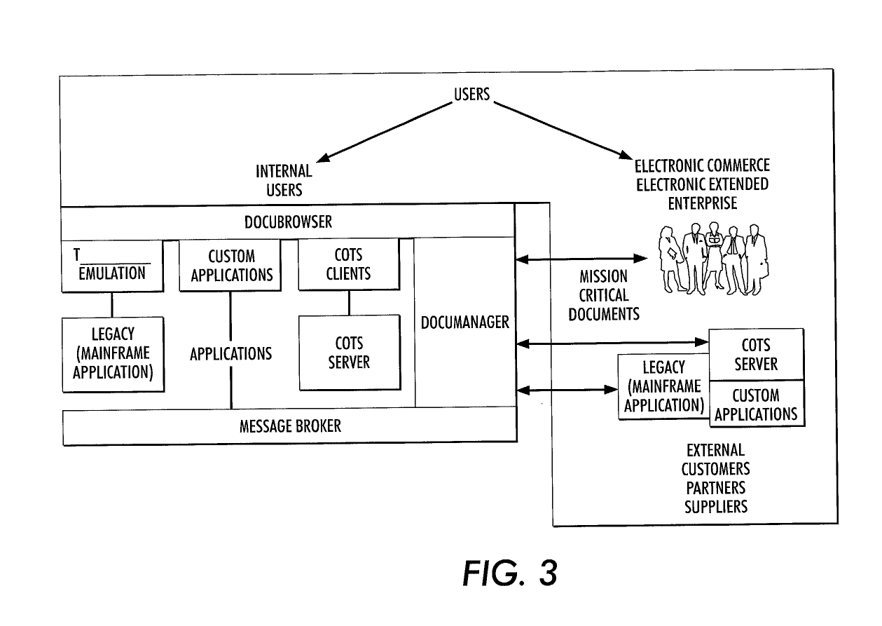

FIG. 3 shows the DocuBroker high-level functions and example environment. The DocuBroker system consists of three major parts: 1) DocuBrowser, 2) Message Broker, and 3) DocuManager. The 4) Applications and 5) Users are not part of the DocuBroker architecture and are shown simply to illustrate capabilities.

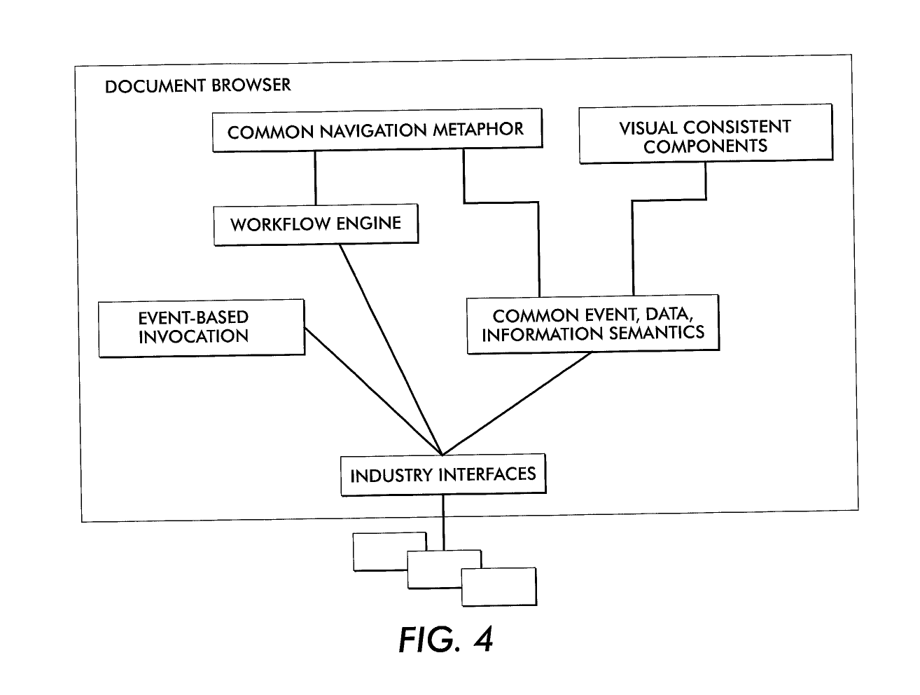

It is unacceptable to end users to interact with a number of independent client applications. The end user needs an integrated client environment that supports their business processes, their workflow. The DocuBrowser part of the DocuBroker Architecture is responsible for client integration. The DocuBrowser is a Web Browser with embedded client applications (or uploadable applets) tightly scripted to facilitate business process or dynamically available depending on user navigation to support the end user's needs. Different types of end users will require different combinations of applications and different scripts. A very special class of end user is the external customer. Using their own Web Browsers, the external customer will be able to create and receive business data through the DocuBrowser. FIG. 4 illustrates the DocuBrowser.

Message Broker is that part of the DocuBroker Architecture responsible for brokering application interactions from server to server, server to client, and client to server. These interactions include synchronous (request/reply) and asynchronous (publishing) data transfer messages, data search/match and transformations, directory services, and equivalent bulk (large message) movements including “smoothing” (turning large volume movements into message oriented movements).

The Message Broker contains the rules for which recipients need to receive which messages. When applications are introduced or retired, or when business processes are changed, the rules in the Message Broker are changed. In this way, the changes to the applications themselves are minimized. To encourage message reuse, messages are accepted by the Message Broker is a “standard” format (canonical). Application “adaptors” are responsible for transforming messages between the standard (canonical) format and whatever format (native) an application requires.

Message adaptors utilize back-end access to applications. Commercial Off The Shelf (COTS) applications usually provide back-end access through Application Programming Interfaces (API's). In legacy applications it may be necessary to create back-end access by such techniques as screen scraping, log scraping or print-queue scraping. Creating a native/local interface to canonical/MessageBroker adapter interface is the only development task necessary for connecting an application to the Message Broker. Adaptors are reused when messages are reused.

Internally, the Message Broker is based on a set of shared middleware services. These services include an asynchronous event service, a synchronous object request service, a bulk data transfer (file transfer) service, and a transaction management service. Built on these basic middleware services are “business objects” capable of forwarding datasets to recipients (data push), requesting datasets from providers (data pull), and responding to updates and events. Externally, the business objects provide integrated access to business data. Data may be requested from (or provided to) the Message Broker, without concern for which applications provide (or receive) the data. This integrated access is available to applications, and is also available for forwarding data for outgoing document construction and from incoming document analysis.

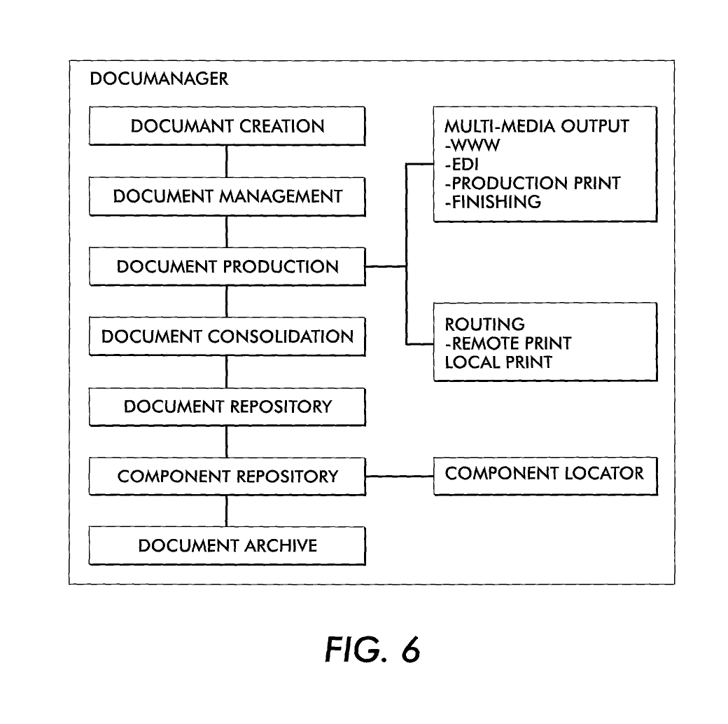

The third major component of the DocuBroker Architecture is DocuManager. DocuManager provides life-cycle management services for mission-critical documents including: design, construction (include template fill and protocol or format translation), distribution (electronic and hardcopy), storage, analysis and workflow. The DocuManager services are used by internal users, via the DocuBrowser, to create, retrieve and review documents. The DocuManager services are used to send documents to, and receive documents from, external customers. External customers also have restricted access to the DocuManager via their Electronic Commerce DocuBrowser. The DocuManager is illustrated in FIG. 6.

Old Program (Legacy) and COTS applications often provide their own functionality for handling mission-critical documents. This functionality, particularly in the Legacy, is usually limited to a few different document formats, with restricted options for storage and distribution. Moreover, the scope of this functionality is bound to the scope of the business application. As a result, it is very difficult to produce integrated documents that consolidate data from multiple applications. Consolidated documents, both for customer statements and internal reporting, are a key business requirement. In summary, the strength of business applications is managing the data lifecycle and not the document lifecycle.

The DocuBroker architecture places DocuManager so that it can be easily integrated and shared across applications. DocuManager services are integrated with Client Applications via the DocuBrowser, and integrated with Legacy and Server Applications via the Message Broker. Document functionality in business applications is either disconnected (Legacy) or not used (COTS). Instead, the business applications supply business data to the DocuManager which creates documents and manages them through their lifecycle. Adaptors may be required to extract data for documents from business applications. COTS applications are usually able to supply the data through an API. Legacy applications may require print-queue scraping in the worst case.

DocuManager is not attempting to compete with desktop document applications (text processing, presentations, spreadsheets, etc). DocuManager is strictly concerned only with mission-critical documents whose lifecycle must be managed in accordance with enterprise business processes. The DocuBrowser may still provide access to desktop document applications for users to produce personal or workgroup documents. These applications may also be configured with “enterprise templates” to become DocuManager client components for document creation.

DocuManager Internals: the major internal components of the DocuManager are shown in FIG. 6. Incoming mission-critical documents (which are converted to business data) are shown on the left of the diagram. Outgoing mission-critical documents (which are constructed from business data) are shown on the right of the diagram. The Document Repository is shared by both incoming and outgoing documents. DocuManager components which are embedded in the DocuBrowser are shown as blue objects. DocuManager components which are server-based are shown as white objects. Data flow is shown with fat arrows, and document flow with thin arrows.

Documents produced from client: Proposals and contracts are produced by a sales person interacting with the customer. Orders may be produced by either a sales person or by a customer via electronic commerce. The data for such documents will be provided via a Client Application. The Client Application may cause the business data to be either created on the client, or extracted from business applications and brought to the client for selection and review. A Client Document Editor is used to construct a document from this data. This editor may be form-based (an order form) or text-based (a solution proposal) and contains all the construction rules required to meet corporate standards for mission-critical documents. The Client Document Editor allows the constructed document to be viewed. The transfer of business data from the Client Application to the Client Document Editor are handled via the DocuBrowser. When a user is satisfied with the document, it is submitted from the Client Document Editor to the Multimedia Output Manager. In the job submission, the user specifies the output media (hardcopy mail, hardcopy handcarry, e-mail, FAX, Web publishing) for distributing the document to the recipients. The Multimedia Output Manager manages the document formatting and distribution for the chosen media and provides status information back to the user. The Multimedia Output Manager will provide a copy of the document to the Document Repository as required by business rules.

Documents produced from mainframe/server: Invoices, Customer Letters and Business Reports are produced when triggered by the business applications. The trigger may be a regular production schedule (e.g. customer X wants all their invoices to be calculated and distributed on a specific day of the month) or some business event (e.g. customer X has agreed to be invoiced for their new equipment when the event “equipment is installed” occurs). The data for producing such documents will be provided by the business applications either as a data file (typical of batched mainframe applications) or as a continuous data stream (more typical of on-line server applications). Data from several applications may be required to produce a single type of document (e.g. a customer might like to see a rollup of invoice items from an Equipment Billing application and a Supplies Billing application). The business data therefore needs to go to a Consolidate Engine for data merging and sorting. The transfer of business data from the business applications to the Consolidate Engine is handled via the Message Broker. Once the business data is consolidated into the form required for documents it is transferred to the Document Constructor. This transfer is also handled via the Message Broker. The Document Constructor relies on document formats developed in the Design Facility to dynamically construct documents from business data. From the Document Constructor documents are sent to the Multimedia Output Manager for distribution. For each document, the Multimedia Output Manager determines the appropriate document representation and distribution media. The Multimedia Output Manager will provide a copy of the document to the Document Repository as required by business rules. The operation of the Consolidate Engine, Document Constructor and Multimedia Output Manager is driven by customer preferences for level of data rollup, document content, document format and output media. Customer preferences are established during interactions with the customer and are stored in a database. During document production, customer preferences are combined with other business data by the consolidate engine. These preferences are then available to the Document Constructor and Multimedia Output Manager to optimize documents for the customer.

Documents received from customers: Remittances, business certificates and general correspondence are mission-critical documents received from customers. These documents are predominantly received as hardcopy today, but will be received increasingly by FAX, E-mail, E-commerce or EDI. The Multimedia Input Manager is responsible for capturing documents electronically, classifying them and producing an output workstream. Part of the workstream can be automated (e.g. determining Accounts Receivable updates from remittance stubs), and part must be handled manually by administrators. The manual workstream is sent to workflow software which distributes work items to administrators. The workflow client is embedded in the DocuBrowser through which administrators can gain access to business applications to make any necessary business data updates. These updates are effected via the DocuBrowser. The automated workstream is sent to the Document Analyzer where optical character recognition is used to extract business data. This data is sent on to the Disseminate Engine which, based on business rules, embeds the data in messages and sends them to the appropriate business applications. The data transfer between the Document Analyzer and the Disseminate Engine, and between the Disseminate Engine and the Business Applications, is handled via the Message Broker. The Document Repository stores both incoming and outgoing documents. Documents can be accessed via the Search Tool. Since the Search Tool is embedded in the DocuBrowser, documents and data from documents can be shared with other client applications.

The DocuBrowser, DocuManager and Message Broker operate synergistically to broker mission-critical documents between business applications and users, and to add-value by managing the enterprise lifecycle of those documents. The DocuBroker effectively decouples the management of mission-critical documents from the management of mission-critical data and information while maintaining relationships. This architecture is unique in that it addresses the full scope of the mission-critical document lifecycle and meets seven key requirements of enterprises undergoing business-process reengineering. There are seven primary requirements in which the DocuBroker Architecture addresses:

1. Legacy to Enterprise Application migration: isolate Business Applications, Business Processes and Users from unnecessary changes as a result of Legacy to Enterprise Application migration.

The Message Broker provides integrated access to business data. As business processes migrate from Legacy to COTS Enterprise Applications, and Legacy applications are retired, only messages and adaptors need to be changed. Other business applications and DocuBroker components do not need to be recoded. In addition, users can be isolated from legacy retirement by providing legacy wrappers in DocuBrowser which interact directly with business objects in the Message Broker.

2. Continuous process evolution: localize the logic implementing business processes so that they can be changed without requiring substantial software redesign.

Business rules are central to the operation of most DocuBroker components, in particular: application brokering rules in the Message Broker, client application integration scripts in the DocuBrowser, data consolidation rules in the Consolidate Engine, document design rules in the Design Facility, distribution rules in the Multimedia Output Manager, and storage rules in the Document Repository. The operation of these components can be adjusted to meet new business process changes by updating the rules. The need to reprogram business applications is minimized.

3. Real-time process execution: enable business processes to execute in real-time by avoiding delays while the state of business data catches up with the state of real-world business operations.

Legacy applications most commonly interact via batch processes which introduce significant end-to-end delays in data and document transmission. The message broker supports real-time messaging between legacy applications, COTS enterprise applications, and DocuBroker components. This allows real-time processes to be exploited to the full amount that the business applications allow. In some circumstances, it may be possible to get renewed life from legacy applications by reconfiguring them to interact via the message broker in real time.

4. Electronic Commerce: ensure that business applications enable use of the World-Wide-Web for Electronic Commerce.

The use of Web technology in DocuBrowser allows end-customers to upload Electronic Commerce applets. From their web browsers, these applets will allow customers to access data from business applications, to view dynamically created documents from business applications, and also to view documents in the DocuManager repository. Strict security capabilities must be incorporated into the DocuBroker architecture to ensure that the privacy of enterprise and customer data is not compromised.

5. Document optimization for individual customers: allow customers to choose the format, content and distribution date of mission-critical documents so that they interface easily with the customers' business processes.

Based on customers' requirements, a number of different document definitions are stored in the Design Facility. An identifier for the appropriate definition is associated with each customer in the customer preferences database. When a document is being constructed by the Document Constructor, the definition identifier is available as part of the incoming business data. This identifier is used to select the document definition preferred by the customer.

6. Consolidated customer documents: allow customers to choose the degree to which they want business data combined and summarized on documents, ranging from a single transaction view to an overall account view.

Based on customers' requirements, a number of different data consolidation rulesets are stored in the Consolidate Engine. An identifier for the appropriate ruleset is associated with each customer in the customer preferences database. This identifier is available to the Consolidate Engine which uses it to apply the ruleset required by the customer.

7. Multiple media for document distribution: allow customers to choose the media for document distribution.

The required document distribution media is associated with each customer in the customer preferences database. This preference is available to the Multimedia Output Manager which uses it to select the media required by the customer.

Wherever feasible, DocuBroker components will utilize commercial off-the-shelf software. Taken individually, these components will not be unique. However, the DocuBroker architecture is unique in putting all these components together in a comprehensive system design which exploits the synergy between components for meeting enterprise business process requirements.

While the invention has been described with reference to the structures disclosed, it is not confined to the specific details set forth, but is intended to cover such modifications or changes as may come within the scope of the following claims.

What is claimed is:

1. A document architecture system for managing documents having business critical data and generating new documents for a user, wherein each of the documents having business critical data are derived across a plurality of heterogeneous program applications and environments, the system comprises:
a DocuBroker for mediating between the plurality of heterogeneous program applications and the documents having business critical data;
a message broker, coacting with said DocuBroker, for retrieving and transferring business critical data from one of said plurality of heterogeneous program applications and environments to be used by another of said plurality of heterogeneous program applications and environments;
a DocuBrowser for selecting selective portions of said business critical data; and
a DocuManager for generating new business documents based on predefine business parameters, in response to said DocuBrowser, said DocuManager include means for analyzing selective portions of said business critical data; means for storing said new business documents, means for distributing said new documents across said plurality of heterogeneous program applications and environments.

2. The system of claim 1, wherein said analyzing means, storing means and distributing means is enable or disable base upon said predefine business parameters.

3. The system of claim 1, wherein said predefine business parameters are determined by the selected of said business critical data.

4. The system of claim 1, wherein said predefine business parameters are determined by the selection of said user.
